(19) United States
(12) Patent Application Publication
(10) Pub. No.: US 2013/0327980 A1
(43) Pub. Date: Dec. 12, 2013

(54) USE OF SURFACTANTS FOR BLENDS OF BIOMASS-DERIVED PYROLYSIS OIL WITH LIPIDS

(71) Applicants: Anjan Ray, New Dehli (IN); Soumendra M. Banerjee, Dwarka (IN)

(72) Inventors: Anjan Ray, New Dehli (IN); Soumendra M. Banerjee, Dwarka (IN)

(73) Assignee: UOP LLC, Des Plaines, IL (US)

(21) Appl. No.: 13/494,820

(22) Filed: Jun. 12, 2012

(51) Int. Cl. C09K 3/00

(52) U.S. Cl. 252/182.12

(57) ABSTRACT

A lipid-based composition including pyrolysis oil derived from biomass, a non-ionic surfactant, and a lipid feedstock is described. The lipid-based composition forms a single-phase, stable mixture. A method of making the lipid-based composition is also described. The lipid-based composition can be used in processes designed for pure lipid feedstocks without the need for any upgrading of the pyrolysis oil and little if any process modification.

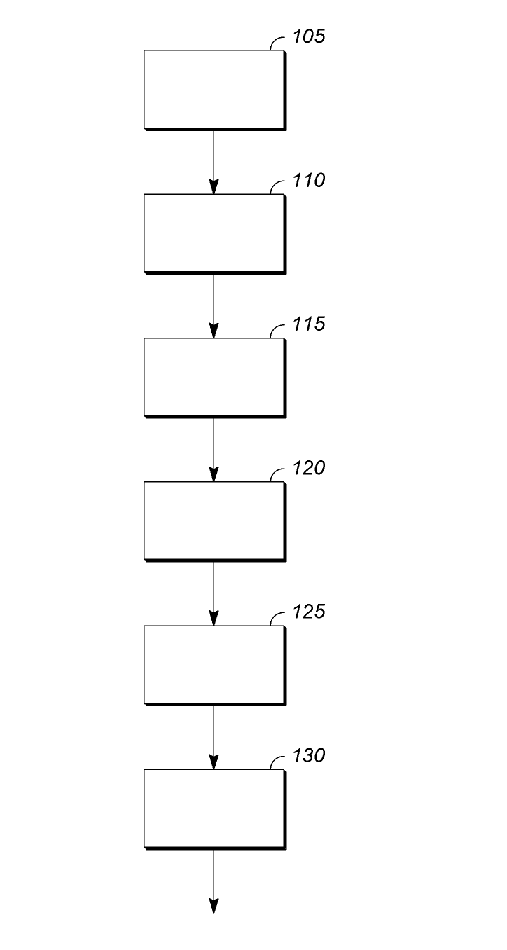

### FIELD OF THE INVENTION

This invention relates generally to renewable feedstocks, and more particularly to a lipid-based composition which combines a lipid feedstock with pyrolysis oil derived from biomass to form a single phase, stable mixture.

### BACKGROUND OF THE INVENTION

Increasing energy demands and limited supplies of petroleum have led to the search for alternative fuels. One potential source of alternative fuels involves processing renewable feedstocks including, but not limited to, plant oils such as corn, jatropha, camelina, rapeseed, canola, soybean and algal oils, as well as animal fats such as tallow. The common feature of these feedstocks is that they are composed of mono- di- and tri-glycerides, and free fatty acids (FAAs).

Processes have been developed for using vegetable oils to produce hydrocarbon fuels, or to provide electricity for off-grid applications in emerging areas of the world. However, the high cost of vegetable oils has limited the development of such fuels and generators.

Another renewable feedstock is lignocellulosic biomass which can be processed into pyrolysis oil. Because lignocellulosic biomass is much more abundant than vegetable oils, pyrolysis oil is less expensive. However, pyrolysis oil has a much higher oxygen content (about 45%) compared to vegetable oil feedstocks (about 11%). Further, it may contain up to about 30% water and also contain acidic components that may cause corrosion. Therefore, pyrolysis oil would require additional upgrading in order to be used in existing processes for the conversion of vegetable oil to hydrocarbons or in existing straight vegetable oil electricity generators.

Moreover, pyrolysis oil is normally immiscible with triglyceride lipids. Consequently, vegetable oil feedstocks cannot be directly combined with pyrolysis oil and used in processes developed for pure vegetable oils.

### SUMMARY OF THE INVENTION

One aspect of the invention is a lipid-based composition. In one embodiment, the composition includes a lipid feedstock; pyrolysis oil derived from biomass dispersed in the lipid feedstock, and a non-ionic surfactant; the lipid-based composition forming a single phase, stable mixture.

Another aspect of the invention involves a method of making a lipid-based composition. In one embodiment, the method includes mixing an effective amount of a non-ionic surfactant into a lipid feedstock to form a first mixture at a temperature at which the lipid feedstock is in a liquid state; and stirring about 1 to about 50 vol % pyrolysis oil derived from biomass into the first mixture to form the lipid-based composition, the lipid-based composition forming a single phase, stable mixture.

### BRIEF DESCRIPTION OF THE DRAWING

The FIGURE is a flow scheme of one embodiment of a process for combining lipid feedstocks with pyrolysis oil.

### DETAILED DESCRIPTION OF THE INVENTION

The present invention provides a composition which can incorporate up to about 50 vol % pyrolysis oil in a lipid feedstock. A non-ionic surfactant is used to overcome phase compatibility issues. The composition is a single phase, stable mixture of the lipid feedstock and the pyrolysis oil, materials which are otherwise immiscible in the absence of the surfactant.

The lipid-based composition increases the available feedstocks for processes designed to use lipid feedstocks. It permits the use of pyrolysis oil in processes designed for lipid feedstocks without the necessity of any intermediate upgrading of the pyrolysis oil and with little or no equipment modification. In addition, it can reduce the cost of the feedstock compared to a pure lipid stream by as much as 15%, even after factoring in the cost of the surfactant. Further, it possibly reduces the potential impact of acidity in pyrolysis oil on storage, handling and end-use equipment, as the lipid-based composition has a higher pH than pyrolysis oil.

Suitable lipid feedstocks include, but are not limited to, vegetable oils, animal fats, algal oils, used cooking oil, triglycerides, esters, fatty acids, or mixtures thereof.

The pyrolysis oil is derived from biomass. It can be included in amounts up to about 50 vol % of the lipid-based composition, or up to about 45 vol %, or up to about 40 vol %, or up to about 35 vol %, or up to about 30 vol %, or up to about 25 vol %, or up to about 20 vol %. There is typically at least about 1 vol % pyrolysis oil in the composition, or at least about 3 vol %, or at least about 5 vol %.

The composition includes an effective amount of non-ionic surfactant, which compatibilizes the lipid feedstock and the pyrolysis oil, and allows the formation of a single phase, stable mixture of the two materials. The selection of the non-ionic surfactant can be optimized for the particular lipid feedstock being used. The amount of non-ionic surfactant varies depending on the particular lipid feedstock and pyrolysis oil being used, and the ratio of these two components in the blend.

An effective amount of surfactant is any amount equal to or above the minimum amount that results in the formation of a single phase, stable mixture. There is no upper limit to the amount of surfactant that can be used. However, above a certain level, the use of more surfactant does not result in the enhancement of the stability of the mixture. Although it is possible to use more than this amount without having a negative physical effect on the composition, the cost of the composition would increase. Consequently, using more than the level that provides the stability benefit is less desirable.

In general, the greater the amount of pyrolysis oil in the composition, the greater the amount of non-ionic surfactant used in the composition. The amount of non-ionic surfactant used is typically at least about 0.2% by weight of pyrolysis oil in the composition, although some surfactants may require at least about 0.3%, or at least about 0.4%, or at least about 0.5%, or at least about 0.6%. Typically, the maximum amount of surfactant that enhanced the stability of the mixture was about 1% by weight of pyrolysis oil in the composition. The amount of surfactant that might be used in practice, depending on the conditions of storage, handling and desired shelf life of the composition, is typically less than about 10% by weight of pyrolysis oil in the composition, or less than about 5%, or less than about 3%, or less than about 2%, or less than about 1%.

Blends of two of more surfactants can be used. In some cases, blends may provide better results than a single surfactant, or else may permit the use of a smaller total amount of surfactant.

Suitable non-ionic surfactants include, but are not limited to, sorbitan esters of fatty acids, polyglycerol esters of fatty acids, mono-glycerides, di-glycerides, mixtures of mono-glycerides and di-glycerides, esters of monofunctional fatty acids with poly-12-hydroxystearic acid, esters of monofunctional alcohols with poly-12-hydroxystearic acid, polymeric esters of difunctional fatty acids, polymeric esters of difunctional alcohols, esters of fatty acids with polyethylene glycol of up to 5 repeat polyoxyethylene units, esters of hydroxyacids with polyethylene glycol of up to 5 repeat polyoxyethylene units, or mixtures thereof.

The composition can also include one or more lower alcohols or polyols with carbon numbers of 3 to 8, such as butanol, propylene glycol and the like, for increased stability, if desired.

The composition is a stable, intimate mixture of the lipid feedstock and the pyrolysis oil. It can be formed using the process illustrated in the FIGURE. Step 105 is an optional heating step for the lipid feedstock, the surfactant, or both. If the lipid feedstock or the selected surfactant or surfactant mixture is a solid or paste at ambient temperature, it is heated to a temperature at which it is a liquid. If either the lipid feedstock or the surfactant is heated, the other should be heated to a temperature within about 5 degrees of the same temperature.

In mixing step 110, the appropriate amount of one or more surfactants (generally in the range of about 0.2 to about 1% by weight of pyrolysis oil to be included) is fed slowly into the lipid phase. To the extent possible, laminar flow mixing should be maintained. In mixing step 115, after all of the surfactant has been mixed in, mixing should be continued for a period of time to ensure thorough mixing of the surfactant in the lipid feedstock. The additional mixing period can be about 15 min to about 2 hr or more.

In mixing step 120, the pyrolysis oil is slowly added to the lipid/surfactant mixture while maintaining mixing and heating (if any). After the addition of the pyrolysis oil has been completed, any heating is turned off, and in mixing step 125, mixing is continued for a period of time, such as about 15 min to about 2 hr or more.

In step 130, the lipid-based composition can be filtered to remove any course particles that may be present, if desired. The lipid-based composition can then be used in processes designed for pure lipid feedstocks without any additional upgrading of the pyrolysis oil or any significant modifications to the process equipment.

### EXAMPLE

### Preparation

### Control

80 ml of crude jatropa oil (CJO) was placed in a beaker. 20 ml of pyrolysis oil was mixed in thoroughly using a magnetic stirrer for about 10 to 15 min. 100 ml of demineralized (DM) water (pH 5.79) was then added, and the DM water was mixed for an additional 10 to 15 min using the magnetic stirrer. The mixture was allowed to stand for about 5 min, and it separated into two phases. The water phase was decanted, and the pH was measured.

### Surfactants

80 ml of CJO was placed in a beaker. The surfactant (0.5 wt % of the pyrolysis oil in the composition) was mixed into the CJO for about 10 to 15 min. 20 ml of pyrolysis oil was mixed in thoroughly using a magnetic stirrer for about 10 to 15 min. 100 ml of DM water was then added, and the DM water was mixed for an additional 10 to 15 min using the magnetic stirrer. The mixture was allowed to stand for about 5 min, and it separated into two phases. The water phase was decanted, and the pH was measured.

The surfactants tested were polyethylene glycol (PEG) 2.5-castor oil (Cresmer 1202, available from Croda India Pvt Ltd), polyethylene glycol ester of poly(12-hydroxy stearic acid) (Cresmer P135, available from Croda India Pvt Ltd), and sorbitan monooleate, available from Venus Ethoxyethers Pvt Ltd. A blend of 0.1% Cresmer P135 and 0.4% sorbitan monooleate, and a blend of 0.3% Cresmer P135 and 0.2% sorbitan monooleate were also tested (pH of DM water was 5.60 for the blends).

### Results

Control - Three phases were observed. A top watery oil phase of approximately 20 ml with a pH of 3.28, a semi-solid middle phase, and a bottom water phase of approximately 80 ml with a pH of 3.31.

Cresmer P135—No phases were observed. Uniform semi-solid with dark yellow color was formed.

Sorbitan monoester - Three phases were observed. There was a top watery oil phase of approximately 50 ml with a pH of 11.93, a semi-solid middle phase, and a bottom water phase of approximately 100 ml with a pH of 3.29.

Blend of 0.1% Cresmer P135 and 0.4% sorbitan monooleate—Three phases were observed. The process of separation was slow (approximately 3 hr). There was a top oil phase of approximately 20 ml with a pH of 5.68, a viscous dark yellow fluid phase in the middle, and a bottom water phase of approximately 75 ml with a pH of 3.25.

Blend of 0.3% Cresmer P135 and 0.2% sorbitan monooleate—No phase separation. Uniform, relatively more viscous, dark yellow fluid/semi-solid phase was formed.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A lipid-based composition comprising:
a lipid feedstock;
pyrolysis oil derived from biomass dispersed in the lipid feedstock; and
a non-ionic surfactant;
the lipid-based composition forming a single phase, stable mixture.

2. The lipid-based composition of claim 1 wherein the pyrolysis oil is about 1 to about 50 vol % of the lipid-based composition.

3. The lipid-based composition of claim 1 wherein the pyrolysis oil about 1 to about 20 vol % of the lipid-based composition.

4. The lipid-based composition of claim 1 wherein the non-ionic surfactant is present in an amount of at least about 0.2% by weight of pyrolysis oil in the lipid-based composition.

5. The lipid-based composition of claim 1 wherein there are at least two non-ionic surfactants.

6. The lipid-based composition of claim 1 wherein the non-ionic surfactant comprises sorbitan esters of fatty acids, polyglycerol esters of fatty acids, mono-glycerides, di-glycerides, mixtures of mono-glycerides and di-glycerides, esters of monofunctional fatty acids with poly-12-hydroxystearic acid, esters of monofunctional alcohols with poly-12-hydroxystearic acid, polymeric esters of difunctional fatty acids, polymeric esters of difunctional alcohols, esters of fatty acids with polyethylene glycol of up to 5 repeat polyoxyethylene units, esters of hydroxyacids with polyethylene glycol of up to 5 repeat polyoxyethylene units, or mixtures thereof.

7. The lipid-based composition of claim 1 wherein the lipid feedstock comprises vegetable oils, animal fats, algal oils, used cooking oil, triglycerides, esters, fatty acids, or mixtures thereof.

8. The lipid-based composition of claim 1 wherein the lipid feedstock is liquid at a temperature at which the lipid-based composition is formed.

9. The lipid-based composition of claim 1 further comprising at least one lower alcohol or polyol having a carbon number from 3 to 8.

10. The lipid-based composition of claim 1 consisting essentially of:
about 1 to about 50 vol % of the lipid-based composition of the pyrolysis oil;
at least about 0.2% by weight of the pyrolysis oil in the lipid-based composition of the non-ionic surfactant;
optionally at least one lower alcohol or polyol having a carbon number from 3 to 8; and
remainder of the lipid feedstock.

11. The lipid-based composition of claim 10 wherein the pyrolysis oil is about 1 to about 20 vol % of the lipid-based composition.

12. The lipid-based composition of claim 10 wherein the non-ionic surfactant comprises sorbitan esters of fatty acids, polyglycerol esters of fatty acids, mono-glycerides, di-glycerides, mixtures of mono-glycerides and di-glycerides, esters of monofunctional fatty acids with poly-12-hydroxystearic acid, esters of monofunctional alcohols with poly-12-hydroxystearic acid, polymeric esters of difunctional fatty acids, polymeric esters of difunctional alcohols, esters of fatty acids with polyethylene glycol of up to 5 repeat polyoxyethylene units, esters of hydroxyacids with polyethylene glycol of up to 5 repeat polyoxyethylene units, or mixtures thereof.

13. The lipid-based composition of claim 10 wherein the lipid feedstock comprises vegetable oils, animal fats, algal oils, used cooking oil, triglycerides, esters, fatty acids, or mixtures thereof.

14. The lipid-based composition of claim 10 wherein the lipid feedstock is liquid at a temperature at which the lipid-based composition is formed.

15. The lipid-based composition of claim 10 wherein at least one lower alcohol or polyol is present.

16. A method of making a lipid-based composition comprising:
mixing an effective amount of a non-ionic surfactant into a lipid feedstock to form a first mixture at a temperature at which the lipid feedstock is in a liquid state; and
stirring about 1 to about 50 vol % of the lipid-based composition of pyrolysis oil derived from biomass into the first mixture to form the lipid-based composition, the lipid-based composition forming a single phase, stable mixture.

17. The method of claim 16 wherein the non-ionic surfactant comprises sorbitan esters of fatty acids, polyglycerol esters of fatty acids, mono-glycerides, di-glycerides, mixtures of mono-glycerides and di-glycerides, esters of monofunctional fatty acids with poly-12-hydroxystearic acid, esters of monofunctional alcohols with poly-12-hydroxystearic acid, polymeric esters of difunctional fatty acids, polymeric esters of difunctional alcohols, esters of fatty acids with polyethylene glycol of up to 5 repeat polyoxyethylene units, esters of hydroxyacids with polyethylene glycol of up to 5 repeat polyoxyethylene units, or mixtures thereof.

18. The method of claim 16 wherein the lipid feedstock comprises vegetable oils, animal fats, algal oils, used cooking oil, triglycerides, esters, fatty acids, or mixtures thereof.

19. The method of claim 16 further comprising heating the lipid feedstock to the temperature at which the lipid feedstock is in the liquid state.

20. The method of claim 16 wherein the non-ionic surfactant is present in an amount of at least about 0.2% by weight of pyrolysis oil in the lipid-based composition
